(19) United States
(12) Patent Application Publication
(10) Pub. No.: US 2024/0103119 A1
(43) Pub. Date: Mar. 28, 2024

(54) PERSONAL DEVICE SENSING BASED ON MULTIPATH MEASUREMENTS

(71) Applicant: QUALCOMM Incorporated, San Diego, CA (US)

(72) Inventors: Jamie Menjay LIN, San Diego, CA (US); Tong TANG, Escondido, CA (US)

(21) Appl. No.: 17/934,598

(22) Filed: Sep. 23, 2022

(51) Int. Cl. G01S 5/02; G06N 3/04; G06N 3/08

(52) U.S. Cl. CPC G01S 5/0278; G06N 3/0472; G06N 3/08

(57) ABSTRACT

Certain aspects of the present disclosure provide techniques for training and using machine learning models to predict locations of stationary and non-stationary objects in a spatial environment. An example method generally includes measuring, by a device, a plurality of signals within a spatial environment. Timing information is extracted from the measured plurality of signals. Based on a machine learning model, the measured plurality of signals within the spatial environment, and the extracted timing information, locations of stationary reflection points and locations of non-stationary reflection points in the spatial environment are predicted. One or more actions are taken by the device based on predicting the locations of stationary reflection points and non-stationary reflection points in the spatial environment.

Aspects of the present disclosure relate to using machine learning to detect objects and the locations of objects in a spatial environment based on wireless communication data.

In a wireless communications system, measurements such as channel state information (CSI) measurements, signal strength measurements (e.g., a received signal strength indicator (RSSI), reference signal received power (RSRP), etc.), and/or other types of measurements of wireless signals can be used for various purposes, such as locating devices or estimating the locations of devices in a spatial environment. In one example, a device may perform location estimation for itself or for other devices in a spatial environment based on triangulation or trilateration of signaling received from multiple anchors. Time difference of arrival (TDoA) and/or time of flight (ToF) information, as well as angle of arrival (AoA) information, may be used to identify the locations of the devices that transmitted the signaling used for location estimation, and thus, to triangulate a location of the device in a spatial environment. In another example, fingerprinting based on data that correlates with location information (e.g., a received signal strength indicator (RSSI), channel state information (CSI) measurements, etc.) may be used to predict the location of various objects in a spatial environment. However, these techniques may impose timing coordination requirements on the anchors in a network, may be specific to a given spatial environment, and may rely on signaling between anchors and devices (e.g., between transmitting devices and receiving devices). Thus, these techniques may be applicable to a specific environment and may involve signaling that can expose sensitive information about users in a wireless communications system.

Accordingly, what is needed are improved techniques for passive location estimation of devices in wireless communication systems.

### BRIEF SUMMARY

Certain embodiments provide a method for predicting locations of stationary and non-stationary objects in a spatial environment using a machine learning model. An example method generally includes measuring, by a device, a plurality of signals within a spatial environment. Timing information is extracted from the measured plurality of signals. Based on a machine learning model, the measured plurality of signals within the spatial environment, and the extracted timing information, locations of stationary reflection points and locations of non-stationary reflection points in the spatial environment are determined. One or more actions are taken by the device based on determining the locations of stationary reflection points and non-stationary reflection points in the spatial environment.

Certain embodiments provide a method for training a machine learning model to predict locations of stationary and non-stationary objects in a spatial environment. An example method generally includes receiving a data set comprising signal measurements. A data set of timing information is extracted from the signal measurements. A machine learning model is trained to predict, based on the data set of signal measurements and the data set of timing information, locations of stationary reflection points in a spatial environment and locations of non-stationary reflection points in the spatial environment.

Other embodiments provide processing systems configured to perform the aforementioned methods as well as those described herein; non-transitory, computer-readable media comprising instructions that, when executed by one or more processors of a processing system, cause the processing system to perform the aforementioned methods as well as those described herein; a computer program product embodied on a computer readable storage medium comprising code for performing the aforementioned methods as well as those further described herein; and a processing system comprising means for performing the aforementioned methods as well as those further described herein.

The following description and the related drawings set forth in detail certain illustrative features of one or more embodiments.

### BRIEF DESCRIPTION OF THE DRAWINGS

The appended figures depict certain aspects of the one or more embodiments and are therefore not to be considered limiting of the scope of this disclosure.

FIG. 1 depicts an example of virtual anchor positioning in a spatial environment based on a non-line-of-sight signal received at a receiving device.

FIG. 2 depicts an example environment in which wireless signals in a spatial environment reflect off of fixed surfaces in the spatial environment.

FIG. 3 depicts example operations for training a machine learning model to predict locations of stationary objects and non-stationary objects in a spatial environment, according to aspects of the present disclosure.

FIG. 4 depicts an example of predicting a location of an object in a spatial environment in which a transmitting device and a receiving device are decoupled, according to aspects of the present disclosure.

FIG. 5 depicts example operations for predicting locations of stationary objects and non-stationary objects in a spatial environment based on a machine learning model and timing information extracted from CSI measurements, according to aspects of the present disclosure.

FIG. 6 depicts an example implementation of a processing system on which a machine learning model is trained to predict locations of stationary objects and non-stationary objects in a spatial environment, according to aspects of the present disclosure.

FIG. 7 depicts an example implementation of a processing system on which a machine learning model is used to predict locations of stationary objects and non-stationary objects in a spatial environment, according to aspects of the present disclosure.

To facilitate understanding, identical reference numerals have been used, where possible, to designate identical elements that are common to the drawings. It is contemplated that elements and features of one embodiment may be beneficially incorporated in other embodiments without further recitation.

### DETAILED DESCRIPTION

Aspects of the present disclosure provide techniques for detecting objects in a spatial environment based on wireless sensing and machine learning models.

Location prediction (or estimation) may be a powerful tool to aid in varying object sensing tasks, such as intrusion detection, object counting, activity recognition and tracking, and boundary entry/exit detection. For example, active positioning may be used by a wireless device to predict its location in a spatial environment based on signals received from one or more transmitters (e.g., base stations, gNodeBs, wireless (e.g., Wi-Fi) access points, etc.) in the spatial environment. In another example, location estimation can be used in passive positioning. In passive positioning, a wireless device can use radio frequency measurements to predict positions of other devices in a spatial environment. Generally, the positions of other devices in a spatial environment can be determined based on perturbation to wireless signals caused by objects obstructing a direct line-of-sight path between a receiving device and a transmitting device.

To detect objects in a spatial environment and determine the locations of these objects in the spatial environment (e.g., relative to some reference point), various techniques may be used to define the spatial environment in which object detection and location determination is performed. For example, environment fingerprinting may generally relate measured signal properties (e.g., CSI measurements, etc.) to specific locations within a specific spatial environment; however, environment fingerprinting is specific to a given spatial environment and not generalizable to other spatial environments. Additionally, because location prediction in a spatial environment may be configured by the persons in control of a spatial environment and may be based on wide area signaling between a receiving device (e.g., a UE) and a transmitting device (e.g., a gNodeB), object detection and location prediction may not be personalized for a specific user and may expose information about owner of a receiving device.

Aspects of the present disclosure provide techniques that allow for the use of signal measurements and machine learning models to sense or detect objects in a spatial environment. By sensing or detecting objects in a spatial environment based on signal measurements, such as CSI, in relation to reflection points (which may also be referred to interchangeably as “wave interaction points” and include reflection, refraction, absorption, and scattering characteristics) in the spatial environment, aspects of the present disclosure may sense objects within a spatial environment without knowledge of the layout of the spatial environment. Further, aspects of the present disclosure may allow for personalized sensing of objects within the spatial environment, for example, by allowing a user to customize detection radii, sensitivity, and other parameters that may define what sensed objects are objects of interest in the spatial environment. Still further, because aspects of the present disclosure may allow for the detection of stationary and non-stationary objects in a spatial environment without transmission of signaling from a receiving device to a transmitting device, aspects of the present disclosure may preserve the privacy of the device(s) which are used to identify objects within the spatial environment.

### Example Multipath Wireless System

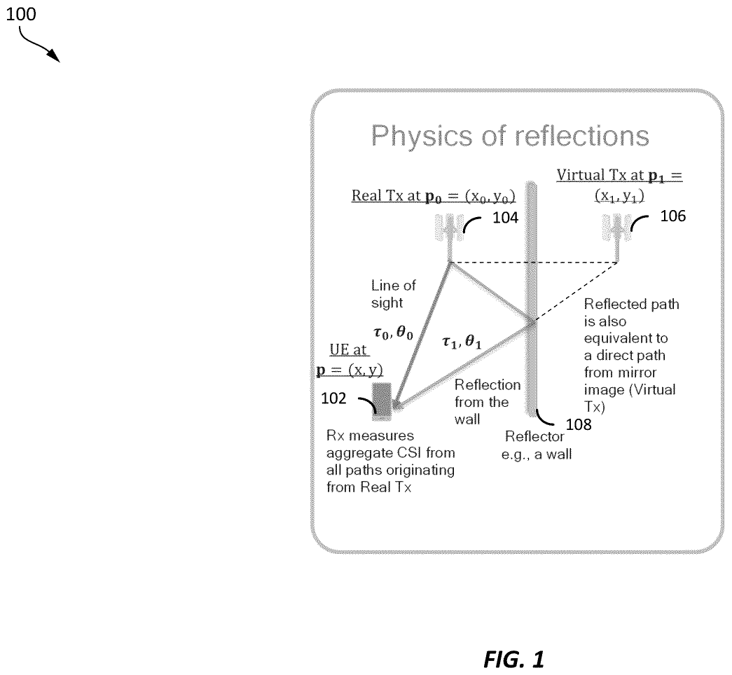

FIG. 1 illustrates an example environment 100 in which a non-line-of-sight component of a signal transmitted to a UE by a real transmitter may be treated as a line-of-sight component of a signal transmitted to the UE by a virtual transmitter. As illustrated, environment 100 includes a UE 102 positioned at p=(x, y) and a real transmitter 104 positioned at p₀=(x₀, y₀). A line-of-sight component of a signal transmitted by the real transmitter 104 has a time of flight to the UE 102 of τ₀ and an angle of arrival of θ₀, and a non-line-of-sight component of the signal transmitted by the real transmitter 104 has a time of flight to the UE 102 of τ₁ and an angle of arrival of θ₁. The non-line-of-sight component results from the signal transmitted by real transmitter 104 being reflected from a reflector 108 in a built environment (e.g., a wall or other surface that can reflect transmitted signal in environment 100).

A reflected path of a non-line-of-sight signal, however, may be equivalent to a direct path from a virtual transmitter 106 in environment 100. For example, the non-line-of-sight may be equivalent to a line-of-sight path from a mirror image of the real transmitter 104 mirrored relative to the surface from which the non-line-of-sight component was reflected. Thus, in environment 100, the non-line-of-sight component of the signal transmitted by the real transmitter 104 with a time of flight to the UE 102 of τ₁ and an angle of arrival of θ₁ may be treated as a line-of-sight component of a signal transmitted by a virtual transmitter 106 positioned at p₁=(x₁, y₁).

UE 102 may generate, based on measurements of received signaling, various measurements that can be used to identify the locations of the real transmitter 104 and one or more virtual transmitters 106 in environment 100. For example, the UE may compute CSI measurements, time of flight measurements, and the like. A time of flight measurement, ToF, may be calculated according to the equation:

$$ToF = τ = \frac{‖ p - {p}_{n} ‖}{c}$$

where n represents an n^{th} transmitter (e.g., real transmitter 104 or virtual transmitter 106) in environment 100, p represents a position of the UE 102, pₙ represents the position of the n^{th} transmitter, and c represents the speed of light.

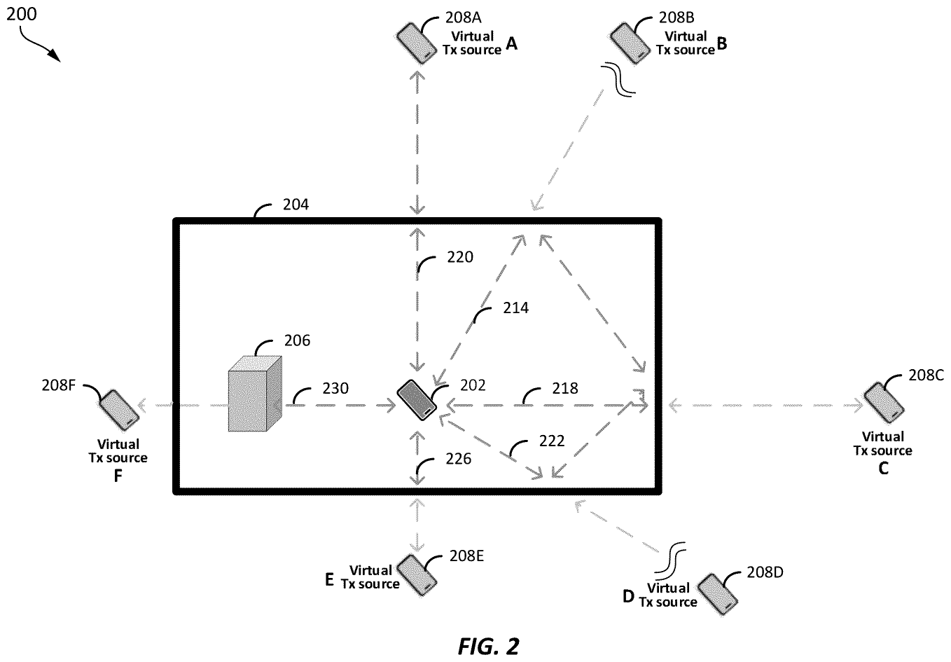

In some aspects, UE 102 (representing a receiver) and real transmitter 104 may be distributed or co-located. Generally, in a distributed system in which a UE 102 is located in a different location from the real transmitter 104 (e.g., a base station, a wireless router, etc.), a UE may passively listen to signaling transmitted by the real transmitter 104 (which, as discussed above, may be treated as signals received from the real transmitter 104 and one or more virtual transmitters 106) without transmitting any signaling itself. Meanwhile, when UE 102 and transmitter 104 are co-located, the UE transmits and receives signaling, as described in further detail below with respect to FIG. 2. In such a case, the received signaling may be treated as signaling received from a plurality of virtual transmitters, which may allow for positioning to be performed independent of other wireless infrastructure (e.g., real transmitters 104) with which a UE 102 can communicate.

FIG. 2 illustrates an example environment 200 in which a wireless communication system is deployed and in which wireless signals in the environment 200 reflect off of fixed surfaces in the environment 200. As illustrated, environment 200 includes a user equipment (UE) 202 in an environment 200 defined by a fixed boundary 204, receiving signals from a plurality of virtual transmitters. In this example, signals may be transmitted by the UE 202, and reflections of these signals from fixed boundary 204 or other objects within a spatial environment may be received at UE 202 and treated as signals received from virtual transmitters located outside of fixed boundary 204. In some aspects, while not illustrated, signals may also or alternatively be transmitted by one or more transmitters (not illustrated) located within fixed boundary 204 and received at UE 202.

As illustrated, signals in environment 200 reflect off of objects in environment 200. For example, signals 210, 214, 218, 222, and 226 correspond to different reflection paths of a transmitted signal from UE 202 off of fixed boundary 204. Meanwhile, signal 230 corresponds to a reflection of a signal transmitted by UE 202 of object 206, which as illustrated is a fixed object within boundary 204 of environment 200. Generally, the distance the signal travels may be defined as the distance between the UE 202 and a virtual transmitter associated with the signal, regardless of whether the signal is directly reflected from boundary 204 and/or object 206 or reflected multiple times off of boundary 204.

Thus, as illustrated, signals 210, 214, 218, 222, and 226 are signals that are transmitted to and received from virtual transmitter sources 208 that are located outside of boundary 204. Signal 210, transmitted with a compass bearing of 0° from UE 202, may be considered a signal transmitted to UE 202 from a virtual transmitter 208A located a distance from boundary 204 that equals the distance between UE 202 and boundary 204. Similarly, signal 214 may be considered a signal transmitted from a virtual transmitter 208B located outside of boundary 204 at a compass bearing of 30°; signal 218 may be considered a signal transmitted from a virtual transmitter 208C located outside of boundary 204 at a compass bearing of 90°; signal 122 may be considered a signal transmitted from a virtual transmitter 208D located outside of boundary 204 at a compass bearing of 120°; and signal 226 may be considered a signal transmitted from a virtual transmitter 208E located outside of boundary 204 at a compass bearing of 180°.

Further, signal 230, as illustrated, reflects off of a stationary object 206 located within boundary 204. Thus, signal 230 may be treated as having been transmitted from a virtual transmitter 208F located a distance from object 206 equal to the distance between UE 202 and stationary object 206. In this example, thus, a virtual transmitter 208F, located outside of boundary 204, may be treated as a transmitter that generated signal 230. However, it should be recognized that signals reflected from stationary objects located within boundary 204 may be considered as signals transmitted from virtual transmitters that are also located within boundary 204 (e.g., when the distance between the stationary object and the UE is less than half the distance between the UE 102 and the boundary 204 along the same compass bearing).

In some cases, signaling within environment 200 may include multipath components caused by reflections from fixed surfaces (e.g., boundary 204 and/or object 206). The multipath components of a transmitted signal may include direct reflections back to the UE 202 from boundary 204 and one or more indirect reflections to the UE from boundary 103 (e.g., signal 214 or signal 222, which reflect off of boundary 204 at a non-perpendicular angle). Each multipath component may be associated with unique timing information and angle of arrival information from the perspective of UE 202. Because each multipath component may be associated with unique timing information and angle of arrival information, each multipath component may be used, effectively, as a line-of-sight component from a different virtual transmitter in environment 200 (as described above with respect to FIG. 1).

### Example Machine Learning Models for Identifying Positions of Stationary and Non-Stationary Objects in a Spatial Environment

To use passive positioning techniques to identify stationary and non-stationary objects (which may be targets having distinct machine-learnable signal propagation/reflection characteristics or signatures based, for example, on the materials from which these objects are composed) in a spatial environment, signal measurements and timing information extracted from these timing measurements are used as inputs into a machine learning model trained to perform various object sensing tasks, such as predicting the locations of stationary and non-stationary objects in the spatial environments, probabilistic recognition of object entry into and exit from defined spaces, object counting, and the like. The resolution at which these locations may be predicted may vary based on the bandwidth of signaling used within the spatial environment and the frequency bands on which signaling is transmitted. For example, in the frequency range 1 (FR1) bands used in 5G communications (e.g., using a bandwidth of 100+ MHz at frequencies below 6 GHz), the spatial resolution of the predicted (or determined) locations may be approximately 3 meters. In the frequency range 2 (FR2) bands used in 5G communications (e.g., millimeter-wave bands at frequencies exceeding 24 GHz), and with a bandwidth of 400 MHz, the spatial resolution of the predicted locations may be as fine as approximately 0.75 meters (75 centimeters). In another example, for wireless signals in a Wi-Fi network (e.g., an 802.11ac or 802.11ax network) transmitted using a bandwidth of 160 MHz in the 2.4 GHz through 5 GHz bands, the spatial resolution may be as fine as approximately 1.875 meters (187.5 centimeters).

Various models can be trained to detect stationary and non-stationary objects in a spatial environment based on signal measurements and timing information extracted from these signal measurements. For example, it may be assumed that humans or other moving objects act as a physical filter that produces detectable patterns of signal reflection, refraction scattering, and penetration. Thus, machine learning models may be trained to differentiate between stationary objects and non-stationary objects (e.g., humans in motion) in a spatial environment and predict the locations of the stationary objects and the non-stationary objects in the spatial environment relative to a device on which location prediction is performed. In some aspects, these models may also use Doppler shift information, relative to a device which is detecting stationary and non-stationary objects in the spatial environment, for signal measurements to detect not just the presence (or absence) of humans in a spatial environment, but detect human activity within the spatial environment. For example, limited to no Doppler shift between different times may indicate that a human is stationary, while other Doppler shift characteristics may indicate varying types of activity, such as walking, running, jumping, etc.

A model that uses signal measurements and timing information extracted from these signal measurements to predict the presence of non-stationary objects (e.g., humans in motion) in a spatial environment and the locations of these non-stationary objects may, in some aspects, be a Gaussian mixture model. Generally, a Gaussian mixture model may be a probabilistic model, implemented as a convolutional neural network, which assumes that data points from the spatial environment are generated from a finite number of Gaussian distributions with unknown parameters. These Gaussian mixture models may be trained, for example, based on received signal energy maximization.

In some aspects, the Gaussian mixture model may be a Bayesian model in which a probability distribution is used to represent uncertainty in the model. The Bayesian model may be defined according to the equation:

$$p ( θ ) = {\sum }_{i = 1}^{M} {λ}_{i} N ( {μ}_{i} , {σ}_{i} )$$

where p(θ) represents the prior distribution, M represents a number of mixture components (or clusters), N represents the number of observations, λᵢ is the mixture weight (or prior probability) of the i^{th} component, μᵢ represents the Gaussian mean of the i^{th} component, and a represents the Gaussian variance of the i^{th} component.

In some aspects, the Gaussian mixture model may be a posterior multivariate Gaussian mixture model in which the prediction of a location in the spatial environment is conditioned based on a set of features x. The set of features x may be, for example, features derived from signal strength and timing information that is selected from a set of non-human-object interference (or otherwise interference associated with objects other than a specific object or type of object of interest) and noise measurements. x may be defined according to the equation:

$$x = {\sum }_{i = 0}^{L - 1} {a}_{i} {e}^{- j 2 π k {τ}_{i}}$$

This equation generally defines a signal model for a wireless multipath channel in a propagation space, in which a phasor represented by e^{-j2πkτ}^{ᵢ} is defined according to the equation:

e^{j}=cos(wt)−j×sin(wt)
where wt is real and j²=−1. w represents the angular frequency and may be defined according to the equation:

w=2×π×k

The term aᵢ is a non-negative real number used to model scaling for the i^{th} component, and the term t represents time. L generally denotes the number of nominal multipath components in a propagation channel, and x is the summation of the L multipath signal components at the receiver. In some aspects, the set of features x may be selected to learn temporal and spatial sub-spacing using various algorithms, such as multiple signal classification (MUSIC), principal component analysis (PCA), or the like.

The posterior multivariate Gaussian mixture model may be defined according to the equation:

$$p ( θ \vert x ) = {\sum }_{i = 1}^{M} {\tilde{λ}}_{i} N ( {\tilde{μ}}_{i} , {\tilde{σ}}_{i} )$$

where \tilde{λ}ᵢ, \tilde{μ}ᵢ, and \tilde{σ}ᵢ represent versions of λ, μ and σ generated based on an expectation maximization algorithm. The energy maximization algorithm generates λ, μ, and σ based on an iterative process that finds a local maximum estimate of these parameters. Generally, the prior distribution and posterior distribution formulas allow for the identification of a probability distribution of CSI samples over the M multipath components identified in a sample.

In some aspects, a model that uses signal measurements and timing information extracted from these signal measurements to predict the presence of non-stationary objects in a spatial environment (e.g., humans or other objects in motion) and the locations of these non-stationary objects may be a probabilistic convolutional neural network. This convolutional neural network may be configured to predict the locations of stationary and non-stationary objects in a spatial environment based on temporal and spatial segmentation of measured signals. The probabilistic model may include one or more kernels with activation parameters associated with detection of a human entering an area, which may be defined a priori or a user-defined area (e.g., as a radius from a device that is monitoring for the entrance of humans or other non-stationary objects into an area). In some aspects, predictions made by the probabilistic model may be used to maintain a counter that tracks the number of humans entering the area over time.

To genericize the machine learning model(s) used to predict or otherwise identify the positions of stationary and non-stationary objects in a spatial environment to any spatial environment, a data set of CSI measurements (or other signal measurements) used to train the machine learning model(s) may include CSI measurements from an environment that is different from an environment in which the machine learning model(s) are deployed. For example, the data set of CSI measurements may include CSI measurements from many different spatial environments with different characteristics (e.g., floor layouts, stationary reflection points, etc.). By training these machine learning model(s) using a data set of CSI measurements that is not specific to a specific design of a spatial environment, the machine learning model(s) may be trained once and deployed for use in any spatial environment.

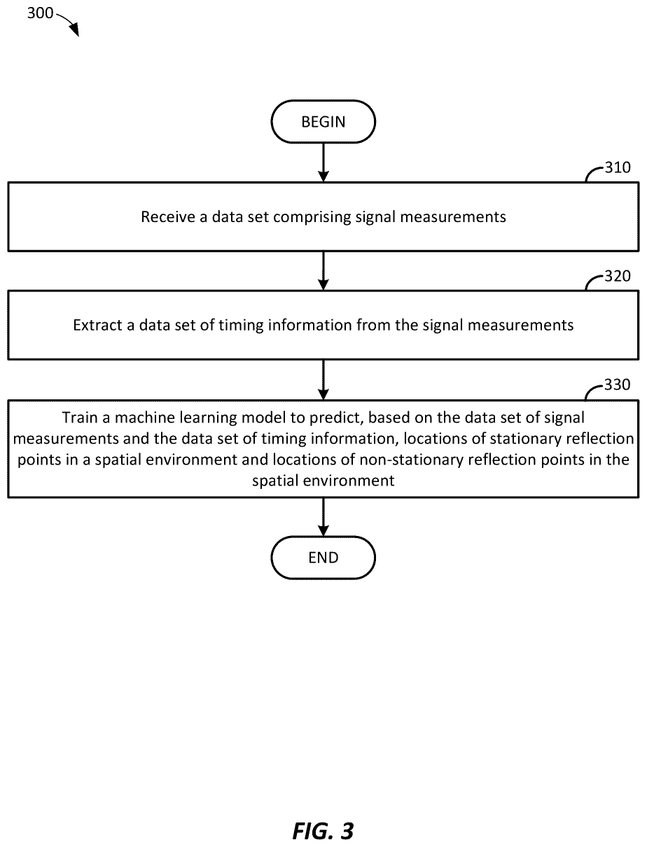

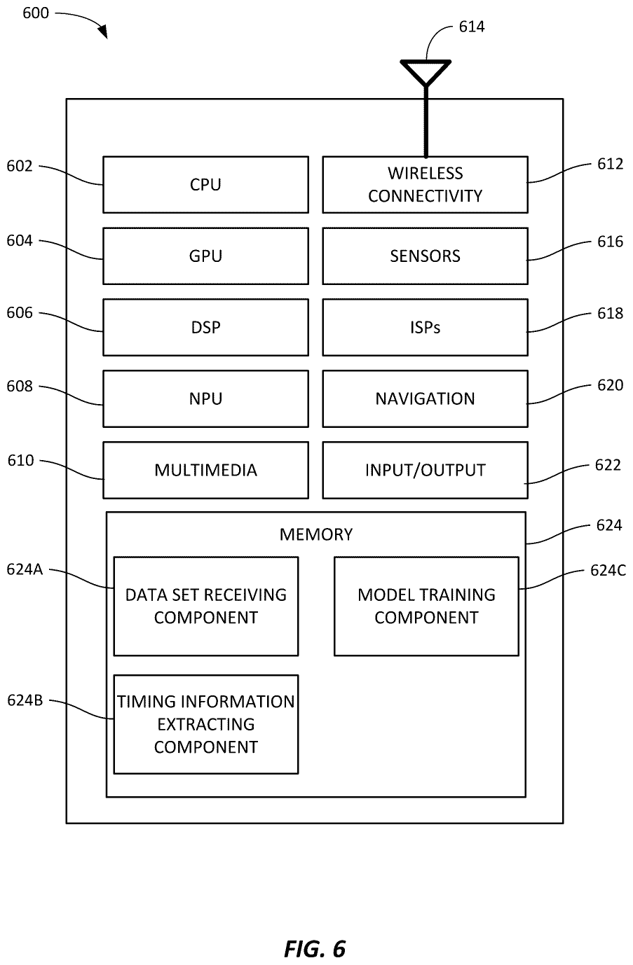

FIG. 3 illustrates example operations that may be performed by a computing system (e.g., system 600 illustrated in FIG. 6 and described below) to train a machine learning model to predict the locations of stationary and non-stationary objects in a spatial environment. Generally, these objects may be considered reflection points from which wireless signals may be reflected towards a device.

As illustrated, operations 300 begin at block 310 with receiving a data set of signal measurements. The data set of signal measurements may include, for example, a data set of CSI measurements. The measurements included in the data set of signal measurements may be measurements from an environment different from a spatial environment in which the machine learning model is deployed so that the machine learning model is decoupled from a specific spatial environment.

At block 320, operations 300 proceed with extracting a data set of timing information from the signal measurements. As discussed, to extract timing information from signal measurements, various techniques can be used to identify virtual transmitters associated with the locations from which a signal is reflected (e.g., to another reflection point, back towards a measuring device, etc.). The timing information can be determined for any given signal measurement based on angular information (e.g., angle of arrival), the position of the device that generated the measurement, the position of a transmitting device, and the like.

Generally, the position of the transmitting device may include real transmitters and virtual transmitters that are associated with reflections in the spatial environment. To account for the increased amount of time a reflected signal takes in being reflected back to the device that generated the measurement, a virtual transmitter associated with a reflected signal may be treated as a transmitter located outside of the spatial environment in which the measurement was generated. For example, if the spatial environment is a room in a building, the virtual transmitter may be located in a different room of the building or even a different building.

At block 330, operations 300 proceed with training a machine learning model to predict, based on the data set of signal measurements and the data set of timing information, locations of stationary reflection points in a spatial environment and locations of non-stationary reflection points in the spatial environment. As discussed, the machine learning model may include a Gaussian mixture model, a probabilistic convolutional neural network, or other machine learning models that can be used to predict the locations of reflection points in a spatial environment, given an input of signal measurements and timing information derived therefrom.

Generally, the characteristics of signals reflected from stationary objects (e.g., walls, columns in a spatial environment, ceilings, etc.) differ significantly from the characteristics of signals reflected from non-stationary objects. To leverage these differences, the machine learning model may, in some aspects, be trained using supervised learning techniques based on signal measurements and timing information labeled with an indication of whether the signal measurements are associated with a stationary object or a non-stationary object. The resulting model may be a probabilistic model that can generate a probability indicating a likelihood of any given measurement being associated with a stationary object or a non-stationary object. In some aspects, the machine learning model may be trained using self-supervised learning or semi-supervised learning techniques, which may allow for the use of unlabeled data or partially annotated ground truth data for training the model.

In some aspects, where the machine learning model is a Gaussian mixture model, the Gaussian mixture model may be a Bayesian model or a posterior multivariate Gaussian mixture model. The Gaussian mixture model may be trained based on received signal energy maximization.

In some aspects, where the machine learning model is a probabilistic convolutional neural network, the machine learning model may be trained to predict the locations, relative to the device, of stationary and non-stationary reflection points (corresponding to stationary and non-stationary objects in a spatial environment) based on temporal and spatial segmentation of measured signals. As discussed, the temporal and spatial segmentation of measured signals may result in the creation of a data set using various temporal and spatial sub-spacing algorithms (e.g., MUSIC, PCA, etc.) such that the data set includes signal measurement information and timing information derived therefrom for stationary objects in a spatial environment. The probabilistic convolutional neural network may include one or more convolutional kernels having activation parameters associated with detection of a human (or other type of moving object of interest) entering an area. In some aspects, the probabilistic convolutional neural network may be configured to recognize humans (or other moving objects) entering an area (which may be defined based on an a priori fixed radius from a device or a user-defined radius from the device) and maintain a counter tracking the number of humans (or other moving objects) entering the area over time.

In some aspects, the locations of non-stationary reflection points in the spatial environment may include locations of humans in motion in the spatial environment. A determination of whether a human is present in the spatial environment and the location of the human may be determined, for example, based on Doppler shift or other information that can be used to identify subject motion in an environment. Different Doppler shift characteristics, for example, may indicate motion towards a device (e.g., where the timing information derived from a signal measurement decreases between different samples), motion away from the device (e.g., where the timing information derived from a signal measurement increases between different samples), or different types of motion (e.g., walking, running, jumping, etc., based on the magnitude of the Doppler shift, with slower motion being associated with lower magnitudes of the Doppler shift than faster motion).

Generally, the machine learning model may be trained to detect stationary and non-stationary objects and predict or otherwise determine the locations of these objects (subject to resolution limitations associated with the frequency bands and bandwidth over which signaling is transmitted and received in a wireless communications network implemented in a spatial environment) in any spatial environment without regard to the specific layout of the spatial environment in which object detection and location estimation is performed. Because the model may be trained to differentiate between stationary and non-stationary objects, the model need not be trained using signal strength fingerprints that would be specific to a particular spatial environment (e.g., a particular floorplan of a room or building). Thus, the model may be portable and may be used across different devices in different spatial environments without customization for any specific user or any specific spatial environment. Further, because the machine learning model uses signal reflections from various objects within a spatial environment to detect stationary and non-stationary objects and predict/determine the locations of these objects, sensitive or otherwise private information may not be exposed to a network operator, unlike models that use transmitter-to-receiver (e.g., base station to user equipment or user equipment to base station) signaling to perform various object detection and location prediction tasks.

### Example Predicting Positions of Stationary and Non-Stationary Objects in a Spatial Environment Using Machine Learning Models

After training, the machine learning models described above may be deployed (e.g., to a user equipment (UE) or other terminal in a wireless communications system) for use in detecting the presence of and positions of stationary and non-stationary objects in a spatial environment. As discussed, because the machine learning models described herein may be trained using a data set of signal measurements and timing information derived therefrom captured from many different spatial environments, the machine learning models described herein may predict the positions and presence of stationary and non-stationary objects in any spatial environment and need not be trained to make predictions for a specific spatial environment.

The machine learning models described above may be used for various range-based or location-based tasks. For example, the machine learning models may be used to detect humans by treating humans as a physical filter that produces detectable patterns (e.g., of signal measurements and timing information derived therefrom). Further, the model can be trained to deactivate responses to non-human objects, which are generally associated with different signal measurement and timing information patterns from humans, and can be trained to use Doppler shift information (as discussed in further detail below) to detect human activity.

In another aspect, the machine learning models may be used for temporal selection and tracking. Generally, an area may be defined relative to a transmitter and receiver (which, as discussed above, may be co-located or distributed). The predictions of the presence of non-stationary objects and the locations of these non-stationary objects (e.g., relative to one or both of the transmitter and/or receiver) may be used to identify entry of a non-stationary object into the area over a given time period and to track movement of the non-stationary object in the area.

In still another aspect, the machine learning models described herein may be used for directional selection and tracking. The machine learning models may be trained to predict a direction from which a non-stationary object is moving relative to a transmitter and receiver (which, again, may be co-located or distributed). Objects that are predicted to be approaching the transmitter and/or receiver may be tracked, while objects that are predicted to be moving away from the transmitter may be (at least temporarily) disregarded.

In some aspects, as discussed in further detail below, the machine learning models may use probabilistic mixture modeling to allow for non-stationary objects (e.g., humans) to be detected within a spatial environment. Based on detecting the presence of non-stationary objects, a counter can be maintained to track the number of non-stationary objects that have entered within an area defined relative to a transmitter and/or receiver, tracking a number of non-stationary objects that are currently within the area defined relative to the transmitter and/or receiver, or the like.

The machine learning model may further be personalized for a specific user. For example, users can define specific measurements (e.g., mass, shape, activity patterns, etc.) that can be disregarded by the model. Thus, the model may be re-trained (or at least refined) to treat objects that conform to these defined measurements as objects that are to be disregarded for purposes of tracking. Subsequently, when the machine learning model receives signal strength measurements and timing information that correlates to an object with these defined measurements, the machine learning model can treat the signal strength measurements and timing information as data belonging to a stationary object (or other disregarded object) rather than flagging the object as a non-stationary object of interest (e.g., for location prediction, tracking, counting, etc., as discussed above).

In one aspect, a transmitter and a receiver may be co-located with each other. For example, a transmitter and a receiver used to generate signaling in a spatial environment and generate measurements based on such signaling may be components of the same device (e.g., a transceiver included in a UE). In such a case, based on predicting the locations of the stationary and non-stationary objects, the device can cancel various components within the plurality of signals measured by the device in the spatial environment. For example, the device can apply various orthogonal or division codes (e.g., Walsh codes) to cancel signals associated with various components or can use various transmission and reception logic or circuits to cancel these signals. In one example, where the signals associated with the non-stationary objects (or reflection points) are of interest, the device can cancel the signals associated with the stationary objects to reduce the number of signals to process. By doing so, an increase in the number of measured signals may indicate entry of another non-stationary object into the spatial environment, while a decrease in the number of measured signals may indicate departure of a non-stationary object from the spatial environment.

In some aspects, predictions of the locations of stationary and non-stationary objects can be used to refine the machine learning model, in concert with known stationary and non-stationary objects (e.g., from the training data set used to train the machine learning model). For example, the machine learning model may be re-trained so that the model disregards some objects as non-stationary objects based on correlations between radio measurements associated with the object and size and shape information associated with the object. For example, suppose that a machine learning model is used to detect the presence of humans in a spatial environment. Because of similarities between humans and other living organisms in terms of reflecting radio signals, the model may flag these other living organisms as humans entering and exiting the spatial environment. However, the model can be retrained to disregard some signals in detecting the presence or absence of humans in the spatial environment, since humans may have a different size and shape than other living organisms (e.g., dogs, cats, etc.) that may be present in the spatial environment.

In some aspects, to identify entry of an object into a spatial environment (e.g., an area defined based on a radius from the device), the device can monitor the predicted (or estimated or determined) locations of non-stationary reflection points in the spatial environment over a period of time. For example, assume that the spatial environment in which the device is operating is larger than the area defined based on the radius from the device. If the device predicts (or estimates or determines) that a non-stationary reflection point is located outside of the area defined based on the radius from the device at time t−1 and predicts (or estimates or determines) that a non-stationary reflection point is located inside the area at time t, the device can determine that an object associated with the non-stationary reflection point has entered the area. In response, the device can generate an alert indicating entry of the object into the area. The device can also maintain a counter of objects in the area, incrementing the counter when an object is determined to have entered the area and (in some aspects) decrementing the counter when an object is determined to have left the area.

In some aspects, the device can detect or predict other information about the location and presence of non-stationary reflection points in the spatial environment. For example, based on the predicted locations over time of the non-stationary reflection points in the spatial environment, angular information relative to the device can be predicted for the objects associated with the non-stationary reflection points. Thus, the device can, in addition to predicting when a non-stationary object (e.g., a human) has entered the area defined based on the radius from the device, predict the direction from which the non-stationary object will approach the device.

The radius from the device based on which the area is defined may be associated with a characteristic of a radio technology used to receive signals in the spatial environment. For example, the radius may be based on a frequency band in which the plurality of signals are received or a bandwidth at which the plurality of signals are received. Generally, the radius may decrease as the bandwidth increases and the frequency band increases and may increase as the bandwidth decreases and the frequency band decreases to accommodate the spatial resolution that is enabled through the use of different bandwidths and frequency bands for transmitting and receiving signaling in a wireless communication network, as discussed above.

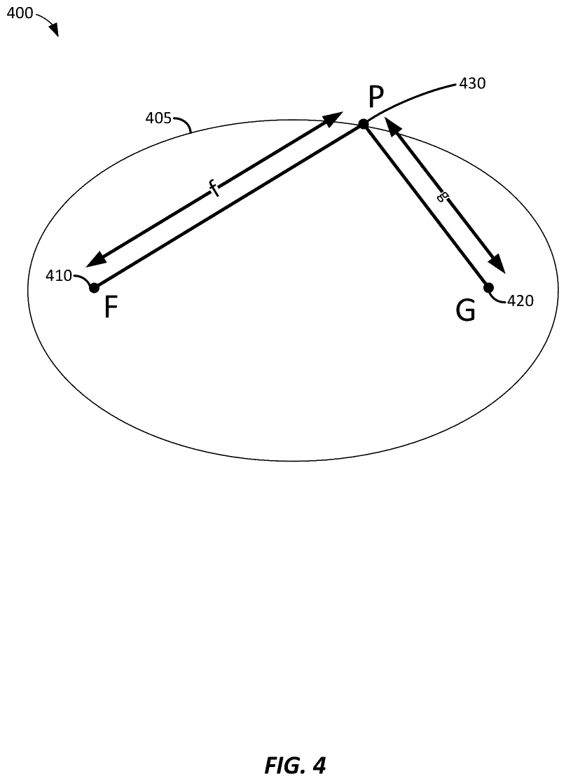

In some aspects, as illustrated in FIG. 4, a transmitter and a receiver may be distributed in the spatial environment 400. The transmitter may be located at a first focal point 410 in ellipse 405, and the receiver may be located at a second focal point 420 in ellipse 405 (or vice versa). In some aspects, the transmitter and the receiver may be time-synchronized peer devices that coordinate to transmit and receive signaling in the spatial environment (e.g., to enable device-specific or manufacturer-specific functionality in a wireless communication system). These time-synchronized peer devices may, in some aspects, operate in cooperation with each other, using manufacturer-specific signaling, to implement manufacturer-specific functionality in the wireless communication system. In coordinating the transmission and reception of signaling, the transmitter and the receiver (located at focal points 410 and 420 of ellipse 405) can coordinate the timing and angle of arrival of signals so that a peer device can cancel some components of a received signal based on the predicted locations of stationary and non-stationary objects in a spatial environment. Predictions of the presence of non-stationary objects and the locations of those non-stationary objects may thus be performed based on distances from the transmitter and distances from the receiver. Further, because location prediction may be performed based on a transmitter and receiver that is distributed within a spatial environment, the resolution at which location predictions may be performed may be increased relative to the resolution at which location predictions are performed when the transmitter and receiver are co-located.

In some aspects, entry of an object (e.g., object 430 illustrated in FIG. 4) into an area defined by the ellipse may be detected based on triangulation from the first focal point and the second focal point. Generally, the location of an object may be defined by a distance from each focal point and an angle from each focal point. Because the distance between the first and the second focal points may be known, location of the object in the spatial environment may be considered the final vertex of a triangle formed by the location of the object, the first focal point, and the second focal point. As with the example discussed above in which the transmitter and receiver are co-located, if a device predicts that a non-stationary reflection point is located outside of the area defined by the ellipse at time t−1 and predicts that a non-stationary reflection point is located inside the area at time t, the device can determine that an object associated with the non-stationary reflection point has entered the area. In response, the device can generate an alert indicating entry of the object into the area. The device can also maintain a counter of objects in the area, incrementing the counter when an object is determined to have entered the area and (in some aspects) decrementing the counter when an object is determined to have left the area.

In some aspects, the device can detect or predict other information about the location and presence of non-stationary reflection points in the spatial environment. For example, based on the predicted locations over time of the non-stationary reflection points in the spatial environment, angular information relative to the device can be predicted for the objects associated with the non-stationary reflection points. Thus, the device can, in addition to predicting when a non-stationary object has entered the area defined by the ellipse, predict the direction from which the non-stationary object will approach the device.

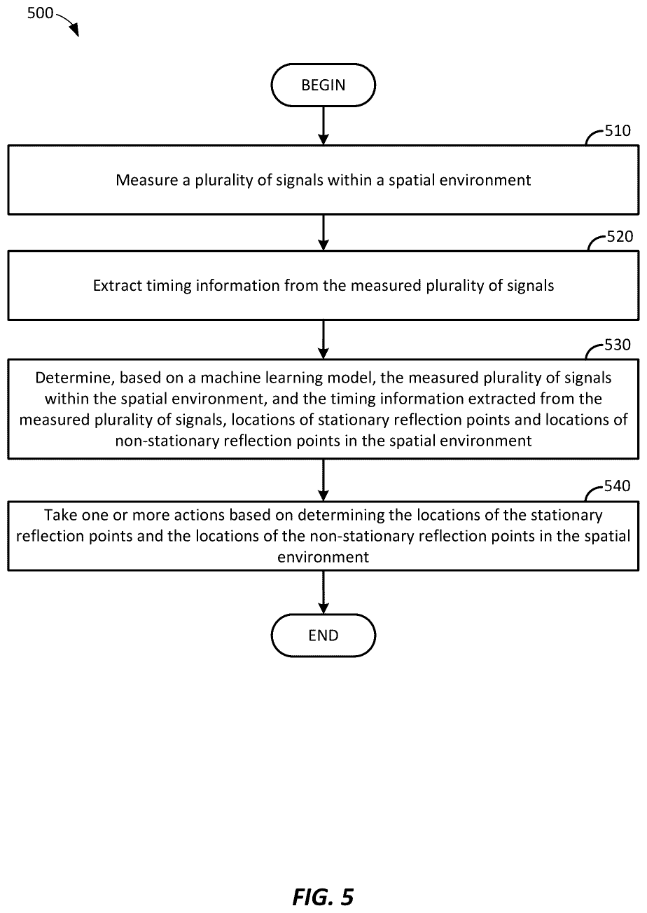

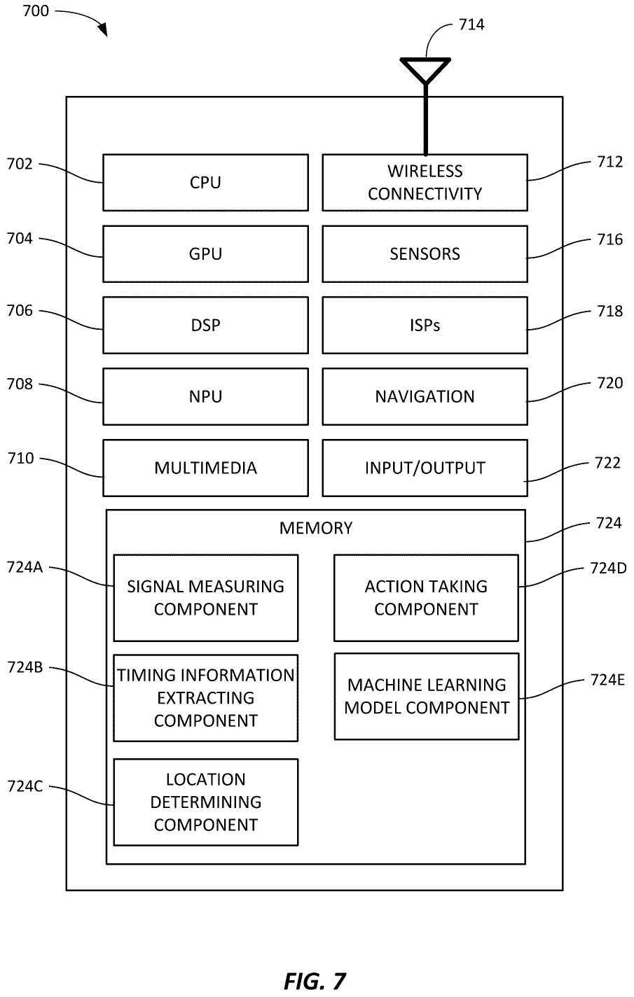

FIG. 5 illustrates example operations 500 that may be performed by a computing device (e.g., system 700 illustrated in FIG. 7) to predict the locations of stationary and non-stationary reflection points (which may correspond to stationary and non-stationary objects) in a spatial environment using a machine learning model. The device may be, for example, a smartphone, a tablet, a laptop, a wearable device, or other computing device that can receive signaling in a wireless network, measure such signaling, extract timing information from such signaling, and predict the locations of stationary and non-stationary reflection points based on the measurements and timing information.

As illustrated, operations 500 begin at block 510 with measuring a plurality of signals within a spatial environment. The measurements may be, for example, CSI measurements generated based on various signals transmitted by the device and reflected back to the device by stationary and non-stationary objects in the spatial environment. These signals may include, for example, CSI reference signals used to measure various signal quality metrics in a wireless communications system or other reference signals that may be transmitted by a device and reflected back to the device by reflection points in the spatial environment.

At block 520, operations 500 proceed with extracting timing information from the measured plurality of signals. As discussed, to extract timing information from signal measurements, various techniques can be used to identify virtual transmitters associated with the locations from which a signal is reflected (e.g., to another reflection point, back towards a measuring device, etc.). The timing information can be determined for any given signal measurement based on angular information (e.g., angle of arrival), the position of the device that generated the measurement, the position of a transmitting device, and the like.

At block 530, operations 500 proceed with determining, based on a machine learning model, the measured plurality of signals within the spatial environment, and the timing information extracted from the measured plurality of signals, locations of stationary reflection points and a presence of non-stationary reflection points in the spatial environment. As discussed, the machine learning model may include a Gaussian mixture model, a probabilistic convolutional neural network, or other machine learning models that can be used to predict the locations of stationary and non-stationary reflection points in a spatial environment, given an input of signal measurements and timing information derived therefrom.

In some aspects, where the machine learning model is a Gaussian mixture model, the Gaussian mixture model may be a Bayesian model or a posterior multivariate Gaussian mixture model. The Gaussian mixture model may be trained based on received signal energy maximization.

In some aspects, where the machine learning model is a probabilistic convolutional neural network, the machine learning model may be trained to predict the locations of stationary and non-stationary reflection points based on temporal and spatial segmentation of measured signals.

At block 540, operations 500 proceed with taking one or more actions at the device based on determining the locations of the stationary reflection points and the non-stationary reflection points in the spatial environment.

In some aspects, the device may include a co-located transmitter and receiver. The one or more actions may include cancelling one or more components within the plurality of signals based on the determined locations of the stationary reflection points in the spatial environment. By cancelling components based on the determined locations of the stationary reflection points in the spatial environment, the device may generate signals including components that are predominantly associated with non-stationary reflection points in the spatial environment.

In some aspects, the one or more actions may include detecting, based on the determined locations of the non-stationary reflection points in the spatial environment, entry of a specified object or type of object into an area defined by a radius from the device. Based on detecting entry of the specified object or type of object into the area, an alert may be generated at the device indicating that the specified object or type of object entered the area.

In some aspects, the one or more actions may include detecting, based on the determined locations of the non-stationary reflection points in the spatial environment over a temporal window defined based on a radius from the device, entry of a specified object or type of object into an area defined by the radius from the device. Based on detecting entry of the specified object or type of object into the area, an alert may be generated indicating that the specified object or type of object entered the area.

In some aspects, the one or more actions may include detecting, based on the determined locations of the non-stationary reflection points in the spatial environment, an angle of departure or an angle of arrival of aa specified object or type of object relative to the device.

In some aspects, the one or more actions may include detecting, based on the determined locations of the non-stationary reflection points in the spatial environment, entry of a specified object or type of object into an area defined by a radius from the device. A counter of objects (which may be defined on a per-object or per-object-type basis) within the radius from the device may be updated based on detecting entry of the specified object or type of object into the area. For example, the counter may be incremented when entry of the specified object or type of object is detected to allow for a running count of objects entering the area to be maintained. In some cases, the counter may be structured to track the current number of non-stationary objects in the area such that the counter is decremented when a specified object or type of object leaves the area.

In some aspects, the device may coordinate transmission and reception of signaling with one or more time-synchronized peer devices based on the determined locations of the stationary reflection points and non-stationary reflection points in the spatial environment. The synchronized peer devices may be located at one focal point of an ellipse, and the device may be located at another focal point of the ellipse. An area defined by the ellipse that is monitored for the entry and exit of non-stationary objects may thus be defined by the distance between the focal points. In some aspects, coordinating transmission and reception of the signaling may include coordinating timing and angle of arrival of one or more signals such that the one or more synchronized peer devices can cancel one or more components within a received signal based on the determined locations of the stationary reflection points and non-stationary reflection points in the spatial environment.

In some aspects, the one or more actions may include detecting, based on the determined locations of the non-stationary reflection points in the spatial environment, entry of a specified object or type of object into an area defined by the ellipse and triangulation from the first focal point and the second focal point. Based on detecting entry of the specified object or type of object into the area, an alert may be generated at the device indicating that the specified object or type of object entered the area. For example, in a personal security application, a specified object may be a human so that alerts are not generated for other objects entering the area, such as non-human animals or specific types of animals.

In some aspects, the one or more actions may include detecting, based on the determined locations of the non-stationary reflection points in the spatial environment over a temporal window defined based on a radius from the device, entry of a specific object or type of object into an area defined by the ellipse and triangulation from the first focal point and the second focal point. Based on detecting entry of the specific object or type of object into the area, an alert may be generated indicating that the specific object or type of object entered the area.

In some aspects, the one or more actions may include detecting, based on the determined locations of the non-stationary reflection points in the spatial environment, an angle of departure or an angle of arrival of a specific object or type of object relative to one of the device or the one or more synchronized peer devices.

In some aspects, the one or more actions may include detecting, based on the determined locations of the non-stationary reflection points in the spatial environment, entry of a specified object or type of object into an area defined by the ellipse and triangulation from the first focal point and the second focal point. A counter of objects within the radius from the device may be updated based on detecting entry of the specific object or type of object into the area. For example, the counter may be incremented when entry of the specific object or type of object is detected to allow for a running count of objects entering the area to be maintained. In some cases, the counter may be structured to track the current number of non-stationary objects in the area such that the counter is decremented when a specified object or type of object leaves the area.

In some aspects, the machine learning model may be retrained to disregard certain specified objects as non-stationary objects. The machine learning model, for example, may be retrained to recognize certain objects based on the shape and size of these objects and consider these objects to be stationary objects based on correlations between radio measurements associated with these objects and the shape and size of these objects.

### Example Processing Systems for Predicting Device and Anchor Location in Spatial Environments Using Machine Learning Models

FIG. 6 depicts an example processing system 600 for training a machine learning models to predict the locations of stationary and non-stationary objects (or reflection points) in a spatial environment, such as described herein for example with respect to FIG. 3.

Processing system 600 includes a central processing unit (CPU) 602, which in some examples may be a multi-core CPU. Instructions executed at the CPU 602 may be loaded, for example, from a program memory associated with the CPU 602 or may be loaded from a memory 624.

Processing system 600 also includes additional processing components tailored to specific functions, such as a graphics processing unit (GPU) 604, a digital signal processor (DSP) 606, a neural processing unit (NPU) 608, a multimedia processing unit 610, a wireless connectivity component 612.

An NPU, such as NPU 608, is generally a specialized circuit configured for implementing control and arithmetic logic for executing machine learning algorithms, such as algorithms for processing artificial neural networks (ANNs), deep neural networks (DNNs), random forests (RFs), and the like. An NPU may sometimes alternatively be referred to as a neural signal processor (NSP), tensor processing units (TPUs), neural network processor (NNP), intelligence processing unit (IPU), vision processing unit (VPU), or graph processing unit.

NPUs, such as NPU 608, are configured to accelerate the performance of common machine learning tasks, such as image classification, machine translation, object detection, and various other predictive models. In some examples, a plurality of NPUs may be instantiated on a single chip, such as a system on a chip (SoC), while in other examples they may be part of a dedicated neural-network accelerator.

NPUs may be optimized for training or inference, or in some cases configured to balance performance between both. For NPUs that are capable of performing both training and inference, the two tasks may still generally be performed independently.

NPUs designed to accelerate training are generally configured to accelerate the optimization of new models, which is a highly compute-intensive operation that involves inputting an existing dataset (often labeled or tagged), iterating over the dataset, and then adjusting model parameters, such as weights and biases, in order to improve model performance. Generally, optimizing based on a wrong prediction involves propagating back through the layers of the model and determining gradients to reduce the prediction error.

NPUs designed to accelerate inference are generally configured to operate on complete models. Such NPUs may thus be configured to input a new piece of data and rapidly process it through an already trained model to generate a model output (e.g., an inference).

In one implementation, NPU 608 is a part of one or more of CPU 602, GPU 604, and/or DSP 606.

In some examples, wireless connectivity component 612 may include subcomponents, for example, for third generation (3G) connectivity, fourth generation (4G) connectivity (e.g., 4G LTE), fifth generation connectivity (e.g., 6G or NR), Wi-Fi connectivity, Bluetooth connectivity, and other wireless data transmission standards. Wireless connectivity component 612 is further connected to one or more antennas 614.

In some examples, one or more of the processors of processing system 600 may be based on an ARM or RISC-V instruction set.

Processing system 600 also includes memory 624, which is representative of one or more static and/or dynamic memories, such as a dynamic random access memory, a flash-based static memory, and the like. In this example, memory 624 includes computer-executable components, which may be executed by one or more of the aforementioned processors of processing system 600.

In particular, in this example, memory 624 includes data set receiving component 624A, timing information extracting component 624B, and machine learning model training component 624C. The depicted components, and others not depicted, may be configured to perform various aspects of the methods described herein.

Generally, processing system 600 and/or components thereof may be configured to perform the methods described herein.

Notably, in other embodiments, aspects of processing system 600 may be omitted, such as where processing system 600 is a server computer or the like. For example, multimedia processing unit 610, wireless connectivity component 612, sensors 616, ISPs 618, and/or navigation component 620 may be omitted in other embodiments. Further, aspects of processing system 600 may be distributed, such as training a model and using the model to generate inferences.

FIG. 7 depicts an example processing system 700 for predicting the locations of stationary and non-stationary objects (reflection points) in a spatial environment using a machine learning model, such as described herein for example with respect to FIG. 5.

Processing system 700 includes a central processing unit (CPU) 702, which in some examples may be a multi-core CPU. Processing system 700 also includes additional processing components tailored to specific functions, such as a graphics processing unit (GPU) 704, a digital signal processor (DSP) 706, and a neural processing unit (NPU) 708. CPU 702, GPU 704, DSP 706, and NPU 708 may be similar to CPU 702, GPU 704, DSP 706, and NPU 708 discussed above with respect to FIG. 6.

In some examples, wireless connectivity component 712 may include subcomponents, for example, for third generation (3G) connectivity, fourth generation (4G) connectivity (e.g., 4G LTE), fifth generation connectivity (e.g., 5G or NR), Wi-Fi connectivity, Bluetooth connectivity, and other wireless data transmission standards. Wireless connectivity component 712 may be further connected to one or more antennas (not shown).

In some examples, one or more of the processors of processing system 700 may be based on an ARM or RISC-V instruction set.

Processing system 700 also includes memory 724, which is representative of one or more static and/or dynamic memories, such as a dynamic random access memory, a flash-based static memory, and the like. In this example, memory 724 includes computer-executable components, which may be executed by one or more of the aforementioned processors of processing system 700.

In particular, in this example, memory 724 includes signal measuring component 724A, timing information extracting component 724B, location determining component 724C, action taking component 724D, and machine learning model component 724E (such as a machine learning model trained by system 600 illustrated in FIG. 6). The depicted components, and others not depicted, may be configured to perform various aspects of the methods described herein.

Generally, processing system 700 and/or components thereof may be configured to perform the methods described herein.

Notably, in other embodiments, aspects of processing system 700 may be omitted, such as where processing system 700 is a server computer or the like. For example, multimedia component 710, wireless connectivity component 712, sensors 717, ISPs 718, and/or navigation component 720 may be omitted in other embodiments.

### EXAMPLE CLAUSES

Implementation details of various aspects are described in the following numbered clauses.
Clause 1: A method, comprising: measuring, by a device, a plurality of signals within a spatial environment; determining, by the device, based on a machine learning model and the measured plurality of signals within the spatial environment, locations of stationary reflection points and locations of non-stationary reflection points in the spatial environment; and taking one or more actions at the device based on determining the locations of stationary reflection points and non-stationary reflection points in the spatial environment.
Clause 2: The method of Clause 1, wherein the device comprises a co-located transmitter and receiver.
Clause 3: The method of Clause 2, wherein the taking one or more actions comprises cancelling one or more components within the plurality of signals based on the determined locations of the stationary reflection points in the spatial environment.
Clause 4: The method of any one of Clauses 2 or 3, wherein taking the one or more actions comprises: detecting, based on the determined locations of the non-stationary reflection points in the spatial environment, entry of an object into an area defined by a radius from the device; and based on detecting entry of the object into the area, generating an alert at the device indicating that the object entered the area.
Clause 5: The method of any one of Clauses 2 through 4, wherein taking the one or more actions comprises: detecting, based on the determined locations of the non-stationary reflection points in the spatial environment over a temporal window defined based on a radius from the device, entry of an object into an area defined by the radius from the device; and based on detecting entry of the object into the area, generating an alert at the device indicating that the object entered the area.
Clause 6: The method of any one of Clauses 2 through 5, wherein the one or more actions comprises detecting, based on the determined locations of the non-stationary reflection points in the spatial environment, an angle of departure or an angle of arrival of an object relative to the device.
Clause 7: The method of any one of Clauses 2 through 6, wherein the one or more actions comprises: detecting, based on the determined locations of the non-stationary reflection points in the spatial environment, entry of an object into an area defined by a radius from the device; and updating a counter of objects within the radius from the device based on detecting entry of the object into the area.
Clause 8: The method of any one of Clauses 2 through 7, further comprising retraining the machine learning model to disregard objects as non-stationary objects based on correlations between radio measurements associated with the object and size and shape information associated with the objects.
Clause 9: The method of any one of Clauses 1 through 8, wherein the taking one or more actions comprises coordinating transmission and reception of signaling with one or more synchronized peer devices based on the determined locations of the stationary reflection points and non-stationary reflection points in the spatial environment.
Clause 10: The method of Clause 9, wherein the coordinating transmission and reception of signaling comprises coordinating timing and angle of arrival of one or more signals such that the one or more synchronized peer devices can cancel one or more components within a received signal based on the determined locations of the stationary reflection points and non-stationary reflection points in the spatial environment.
Clause 11: The method of any one of Clauses 9 or 10, wherein the device is located at a first focal point in an ellipse and the one or more synchronized peer devices are located at a second focal point in the ellipse.
Clause 12: The method of Clause 11, wherein taking the one or more actions comprises: detecting, based on the determined locations of the non-stationary reflection points in the spatial environment, entry of an object into an area defined by the ellipse and triangulation from the first focal point and the second focal point; and based on detecting entry of the object into the area, generating an alert at the device indicating that the object entered the area.
Clause 13: The method of any one of Clauses 11 or 12, wherein taking the one or more actions comprises: detecting, based on the determined locations of the non-stationary reflection points in the spatial environment over a temporal window defined based on a radius from the device, entry of an object into an area defined by the ellipse and triangulation from the first focal point and the second focal point; and based on detecting entry of the object into the area, generating an alert at the device indicating that the object entered the area.
Clause 14: The method of any one of Clauses 11 through 13, wherein the one or more actions comprises detecting, based on the determined locations of the non-stationary reflection points in the spatial environment, an angle of departure or an angle of arrival of an object relative to one of the device or the one or more synchronized peer devices.
Clause 15: The method of any one of Clauses 11 through 14, wherein the one or more actions comprises: detecting, based on the determined locations of the non-stationary reflection points in the spatial environment, entry of an object into an area defined by the ellipse and triangulation from the first focal point and the second focal point; and updating a counter of objects within the ellipse based on detecting entry of the object into the area.
Clause 16: The method of any one of Clauses 11 through 15, further comprising retraining the machine learning model to disregard objects as non-stationary objects based on correlations between radio measurements associated with the object and size and shape information associated with the objects.
Clause 17: The method of any one of Clauses 1 through 16, wherein the machine learning model comprises a Gaussian mixture model.
Clause 18: The method of any one of Clauses 1 through 17, wherein the machine learning model comprises a probabilistic convolutional neural network configured to predict locations of the stationary reflection points and non-stationary reflection points based on temporal and spatial segmentation of measured signals.
Clause 19: The method of any one of Clauses 1 through 18, further comprising retraining the machine learning model to disregard one or more specified objects in predicting the locations of the stationary reflection points and the non-stationary reflection points in the spatial environment.
Clause 20: The method of any one of Clauses 1 through 19, wherein: the plurality of signals comprises measuring the plurality of signals comprises one or more reference signals; and measuring the plurality of signals comprises measuring channel state information (CSI) from the one or more reference signals.
Clause 21: The method of any one of Clauses 1 through 20, wherein the device comprises one of a smartphone, a tablet, a laptop, or a wearable device.
Clause 22: A method, comprising: receiving a data set of signal measurements; extracting a data set of timing information from the data set of signal measurements; and training a machine learning model to predict, based on the data set of signal measurements and the data set of timing information, locations of stationary reflection points in a spatial environment and locations of non-stationary reflection points in the spatial environment.
Clause 23: The method of Clause 22, wherein the machine learning model comprises a Gaussian mixture model.
Clause 24: The method of Clause 23, wherein the Gaussian mixture model comprises one of a Bayesian model trained based on received signal energy maximization or a posterior multivariate Gaussian mixture model trained based on received signal energy maximization.
Clause 25: The method of any one of Clauses 22 through 24, wherein the machine learning model comprises a probabilistic convolutional neural network configured to predict locations of the stationary reflection points and non-stationary reflection points based on temporal and spatial segmentation of measured signals.
Clause 26: The method of Clause 25, wherein the probabilistic convolutional neural network comprises one of: one or more convolutional kernels with activation parameters associated with detection of a human entering an area, or a probabilistic model configured to recognize humans entering an area and maintain a counter tracking a number of humans entering the area over time.
Clause 27: The method of any one of Clauses 22 through 26, wherein the locations of non-stationary reflection points in the spatial environment comprises locations of humans in motion in the spatial environment.
Clause 28: The method of any one of Clauses 22 through 27, wherein the data set of signal measurements comprises a data set of channel state information (CSI) measurements from an environment different from a spatial environment in which the machine learning model is deployed.
Clause 29: A processing system, comprising: a memory comprising computer-executable instructions; one or more processors configured to execute the computer-executable instructions and cause the processing system to perform a method in accordance with any one of Clauses 1-28.
Clause 30: A processing system, comprising means for performing a method in accordance with any one of Clauses 1-28.
Clause 31: A non-transitory computer-readable medium comprising computer-executable instructions that, when executed by one or more processors of a processing system, cause the processing system to perform a method in accordance with any one of Clauses 1-28.
Clause 32: A computer program product embodied on a computer-readable storage medium comprising code for performing a method in accordance with any one of Clauses 1-28.

### ADDITIONAL CONSIDERATIONS

The preceding description is provided to enable any person skilled in the art to practice the various embodiments described herein. The examples discussed herein are not limiting of the scope, applicability, or embodiments set forth in the claims. Various modifications to these embodiments will be readily apparent to those skilled in the art, and the generic principles defined herein may be applied to other embodiments. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, the word “exemplary” means “serving as an example, instance, or illustration.” Any aspect described herein as “exemplary” is not necessarily to be construed as preferred or advantageous over other aspects.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining, and the like. Also, “determining” may include receiving (e.g., receiving information), accessing (e.g., accessing data in a memory), and the like. Also, “determining” may include resolving, selecting, choosing, establishing, and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The following claims are not intended to be limited to the embodiments shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A processor-implemented method, comprising:
measuring, by a device, a plurality of signals within a spatial environment;
extracting, by the device, timing information from the measured plurality of signals within the spatial environment;
determining, by the device, based on a machine learning model, the measured plurality of signals within the spatial environment, and the extracted timing information, locations of stationary reflection points and locations of non-stationary reflection points in the spatial environment; and
taking one or more actions at the device based on determining the locations of stationary reflection points and non-stationary reflection points in the spatial environment.

2. The method of claim 1, wherein the device comprises a co-located transmitter and receiver.

3. The method of claim 2, wherein the taking one or more actions comprises cancelling one or more components within the plurality of signals based on the determined locations of the stationary reflection points in the spatial environment.

4. The method of claim 2, wherein taking the one or more actions comprises:
detecting, based on the determined locations of the non-stationary reflection points in the spatial environment, entry of an object into an area defined by a radius from the device; and
based on detecting entry of the object into the area, generating an alert at the device indicating that the object entered the area.

5. The method of claim 2, wherein taking the one or more actions comprises:
detecting, based on the determined locations of the non-stationary reflection points in the spatial environment over a temporal window defined based on a radius from the device, entry of an object into an area defined by the radius from the device; and
based on detecting entry of the object into the area, generating an alert at the device indicating that the object entered the area.

6. The method of claim 2, wherein the one or more actions comprises detecting, based on the determined locations of the non-stationary reflection points in the spatial environment, an angle of departure or an angle of arrival of an object relative to the device.

7. The method of claim 2, wherein the one or more actions comprises:
detecting, based on the determined locations of the non-stationary reflection points in the spatial environment, entry of an object into an area defined by a radius from the device; and
updating a counter of objects within the radius from the device based on detecting entry of the object into the area.

8. The method of claim 2, further comprising retraining the machine learning model to disregard objects as non-stationary objects based on correlations between radio measurements associated with the object and size and shape information associated with the objects.

9. The method of claim 1, wherein the taking one or more actions comprises coordinating transmission and reception of signaling with one or more synchronized peer devices based on the determined locations of the stationary reflection points and non-stationary reflection points in the spatial environment.

10. The method of claim 9, wherein the coordinating transmission and reception of signaling comprises coordinating timing and angle of arrival of one or more signals such that the one or more synchronized peer devices can cancel one or more components within a received signal based on the determined locations of the stationary reflection points and non-stationary reflection points in the spatial environment.

11. The method of claim 9, wherein the device is located at a first focal point in an ellipse and the one or more synchronized peer devices are located at a second focal point in the ellipse.

12. The method of claim 11, wherein taking the one or more actions comprises:
detecting, based on the determined locations of the non-stationary reflection points in the spatial environment, entry of an object into an area defined by the ellipse and triangulation from the first focal point and the second focal point; and
based on detecting entry of the object into the area, generating an alert at the device indicating that the object entered the area.

13. The method of claim 11, wherein taking the one or more actions comprises:
detecting, based on the determined locations of the non-stationary reflection points in the spatial environment over a temporal window defined based on a radius from the device, entry of an object into an area defined by the ellipse and triangulation from the first focal point and the second focal point; and
based on detecting entry of the object into the area, generating an alert at the device indicating that the object entered the area.

14. The method of claim 11, wherein the one or more actions comprises detecting, based on the determined locations of the non-stationary reflection points in the spatial environment, an angle of departure or an angle of arrival of an object relative to one of the device or the one or more synchronized peer devices.

15. The method of claim 11, wherein the one or more actions comprises:
detecting, based on the determined locations of the non-stationary reflection points in the spatial environment, entry of an object into an area defined by the ellipse and triangulation from the first focal point and the second focal point; and
updating a counter of objects within the ellipse based on detecting entry of the object into the area.

16. The method of claim 11, further comprising retraining the machine learning model to disregard objects as non-stationary objects based on correlations between radio measurements associated with the object and size and shape information associated with the objects.

17. The method of claim 1, wherein the machine learning model comprises a Gaussian mixture model.

18. The method of claim 1, wherein the machine learning model comprises a probabilistic convolutional neural network configured to predict locations of the stationary reflection points and non-stationary reflection points based on temporal and spatial segmentation of measured signals.

19. The method of claim 1, further comprising retraining the machine learning model to disregard one or more specified objects in predicting the locations of the stationary reflection points and the non-stationary reflection points in the spatial environment.

20. The method of claim 1, wherein:
the plurality of signals comprises measuring the plurality of signals comprises one or more reference signals; and
measuring the plurality of signals comprises measuring channel state information (CSI) from the one or more reference signals.

21. The method of claim 1, wherein the device comprises one of a smartphone, a tablet, a laptop, or a wearable device.

22. A processor-implemented method, comprising:
receiving a data set of signal measurements;
extracting a data set of timing information from the data set of signal measurements; and
training a machine learning model to predict, based on the data set of signal measurements and the data set of timing information, locations of stationary reflection points in a spatial environment and locations of non-stationary reflection points in the spatial environment.

23. The method of claim 22, wherein the machine learning model comprises a Gaussian mixture model.

24. The method of claim 23, wherein the Gaussian mixture model comprises one of a Bayesian model trained based on received signal energy maximization or a posterior multivariate Gaussian mixture model trained based on received signal energy maximization.

25. The method of claim 22, wherein the machine learning model comprises a probabilistic convolutional neural network configured to predict locations of the stationary reflection points and non-stationary reflection points based on temporal and spatial segmentation of measured signals.

26. The method of claim 25, wherein the probabilistic convolutional neural network comprises one of:
one or more convolutional kernels with activation parameters associated with detection of a human entering an area, or
a probabilistic model configured to recognize humans entering an area and maintain a counter tracking a number of humans entering the area over time.

27. The method of claim 22, wherein the locations of non-stationary reflection points in the spatial environment comprises locations of humans in motion in the spatial environment.

28. The method of claim 22, wherein the data set of signal measurements comprises a data set of channel state information (CSI) measurements from an environment different from a spatial environment in which the machine learning model is deployed.

29. A system, comprising:
a memory having executable instructions stored thereon; and
a processor configured to execute the executable instructions to cause the system to:
measure a plurality of signals within a spatial environment;
extract timing information from the measured plurality of signals within the spatial environment;
determine, based on a machine learning model, the measured plurality of signals within the spatial environment, and the extracted timing information, locations of stationary reflection points and locations of non-stationary reflection points in the spatial environment; and
take one or more actions based on predicting the locations of stationary reflection points and non-stationary reflection points in the spatial environment.

30. A system, comprising:
a memory having executable instructions stored thereon; and
a processor configured to execute the executable instructions to cause the system to:
receive a data set of signal measurements;
extract a data set of timing information from the data set of signal measurements; and
train a machine learning model to predict, based on the data set of signal measurements and the data set of timing information, locations of stationary reflection points in a spatial environment and locations of non-stationary reflection points in the spatial environment.
